(19) United States
(12) Patent Application Publication
(10) Pub. No.: US 2003/0197780 A1
(43) Pub. Date: Oct. 23, 2003

(54) Method of recording image conversion parameters in annular images, and annular image data recorded with image conversion parameters

(76) Inventors: Osamu Iwaki, Toyama-shi (JP); Naoki Takamoto, Toyama-shi (JP); Kazuya Mitsuyama, Toyama-shi (JP); Masato Imamura, Toyama-shi (JP)

Correspondence Address: ARENT FOX KINTNER, PLOTKIN & KAHN, PLLC, Suite 400, 1050 Connecticut Avenue, N.W., Washington, DC, 20036-5339, US

(21) Appl. No.: 10/173,584

(22) Filed: Jun. 18, 2002

(30) Foreign Application Priority Data
Apr. 17, 2002 (JP) 2002-114376

(51) Int. Cl. G06T 3/00

(52) U.S. Cl. 348/36; 382/284; 382/287; 382/294

(57) ABSTRACT

Image data is provided which has image conversion parameters recorded in an image format in an unphotographed area of an annular image, the annular image being shot by an omnidirectional camera. Thus the image conversion parameters are stored or transmitted along with the annular image in the same format.

### BACKGROUND OF THE INVENTION

### Field of the Invention

The present invention relates to image data recorded with image conversion parameters used to develop an annular image shot by an omnidirectional electric camera into a panoramic image.

To convert an annular image shot by an omnidirectional camera lens (PAL lens) into a panoramic image requires image conversion parameters. Although storing or distributing the converted panoramic image does not require the image conversion parameters, it is not possible without these parameters to change the way the panoramic image is cut and arranged or to correct distortions produced at the ends of the panoramic image.

To deal with this problem, it is conceivable to store image conversion parameters along with the annular image data. Since the image conversion parameters and the annular image data have different data format, commonly available image display application software cannot display the original annular image. Thus, dedicated software is necessary for image search.

### SUMMARY OF THE INVENTION

An object of the present invention is to provide image data having image conversion parameters written in an unphotographed area of an annular image shot by a PAL camera lens.

According to one aspect, the present invention provides image data having image conversion parameters written into an unphotographed area of an annular image in the form of color data, binary image data or bar code data.

### BRIEF DESCRIPTION OF THE DRAWINGS

FIG. 1 is a block diagram showing an entire system configuration according to the present invention.

FIG. 2 illustrates an example of an annular image according to the present invention.

FIG. 3 illustrates a panoramic image obtained by developing the annular image of FIG. 3.

FIG. 4 is a block diagram showing how a correction condition is used according to the present invention.

FIG. 5 is a flow chart showing an example procedure for determining the correction condition of FIG. 4.

FIGS. 6A-6D are explanatory diagrams used to explain the flow chart of FIG. 5.

FIGS. 7A and 7B are diagrams showing correction data obtained as a result of executing the flow chart of FIG. 5.

FIG. 8 is a table of example image conversion parameters.

FIG. 9 is an explanatory diagram showing a location in the annular image where the image conversion parameters are recorded.

FIGS. 10A-10C illustrate example cases where the image conversion parameters are recorded in the form of color information.

FIGS. 11A-11C illustrate example cases where the image conversion parameters are recorded in the form of binary color images.

FIGS. 12A-12C illustrate example cases where the image conversion parameters are recorded in the form of bar codes.

### DETAILED DESCRIPTION OF PREFERRED EMBODIMENTS

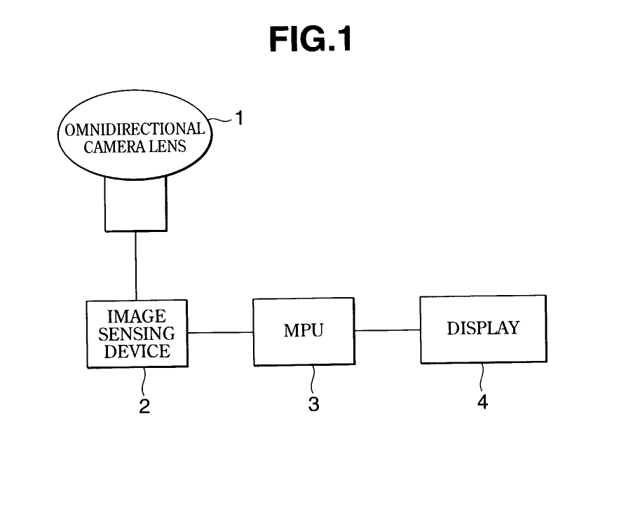

FIG. 1 is a block diagram showing an overall configuration of a system of this invention including a reference position detector for an omnidirectionally photographed annular image.

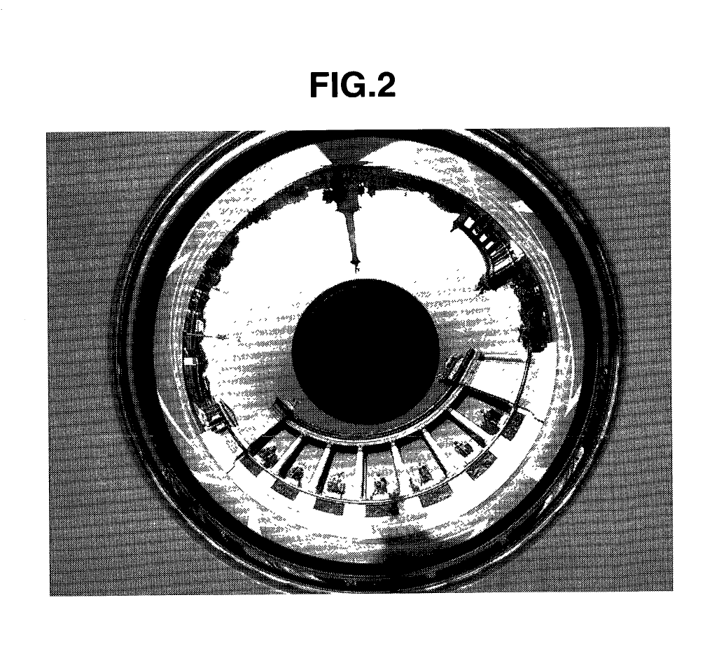

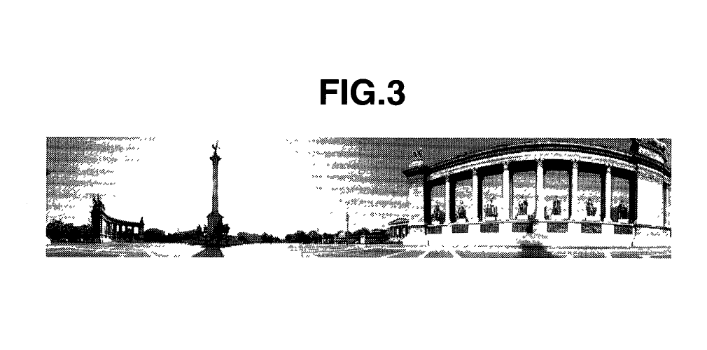

In FIG. 1, an omnidirectional camera lens 1 receives rays of light from an object omnidirectionally through 360 degrees and forms an image of the object on an image sensing device 2. The image sensing device 2 converts the object image into an electric signal and transfers it as digital image data to an MPU 3. The MPU 3 stores in memory the digital image data in the form of an annular image as shown in FIG. 2 and then converts it into a panoramic unfolded image as shown in FIG. 3. The panoramic image is displayed on a display 4.

When converting the annular image of FIG. 2 into the panoramic unfolded image of FIG. 3, it is important that a reference position comprising a center position, an inner circle position and an outer circle position of the annular image be set correctly. This reference position comprises a center coordinate (X0, Y0), an inner circle radius Rin and an outer circle radius Rout.

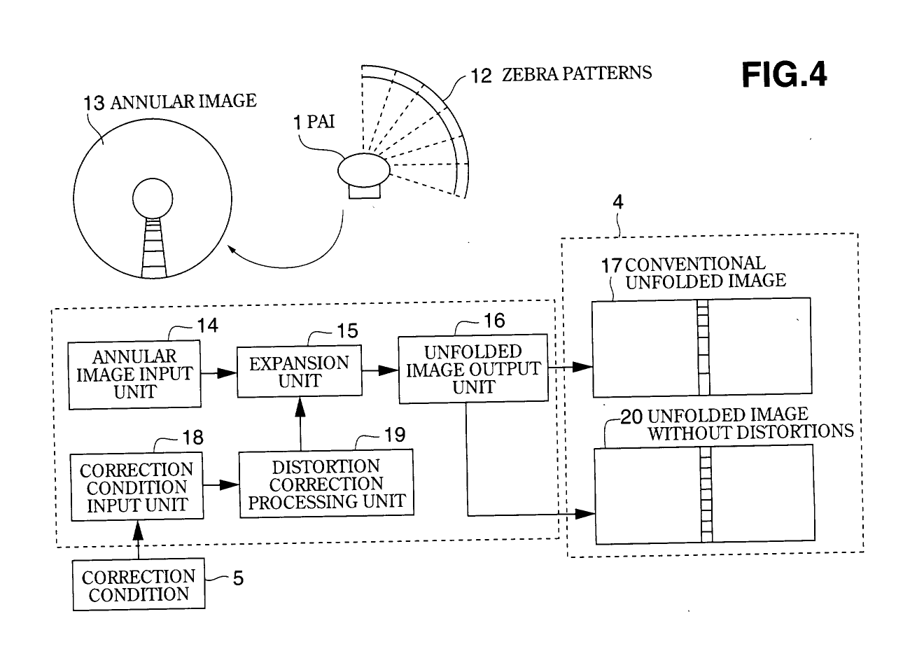

FIG. 4 is a block diagram showing an outline configuration of an omnidirectional camera system of this invention to explain how vertical distortions are corrected. In FIG. 4, when zebra patterns 12 arranged at equiangular intervals are shot by the PAL lens 1, an annular image 13 is obtained. This annular image is taken into an annular image input unit 14 in the form of annular image data, which is converted into panoramic unfolded image data by an expansion unit 15. The unfolded image data is sent from an unfolded image output unit 16 to the display 4 where it is displayed. When the annular image data is simply unfolded by the expansion unit 15 into a panoramic image, the panoramic image exhibits vertical distortions as is, like those 17 shown in FIG. 3.

In this example, a vertical distortion correction condition 5 is supplied into a correction condition input unit 18 and is converted into distortion correction data by a distortion correction processing unit 19. When unfolding the annular image data supplied from the annular image input unit 14 into the panoramic image, the expansion unit 15 corrects the vertical distortions by using the distortion correction data supplied from the distortion correction processing unit 19 and then outputs the distortion-corrected panoramic image to the unfolded image output unit 16. As a result, the display 4 can show a panoramic image 20 without vertical distortions.

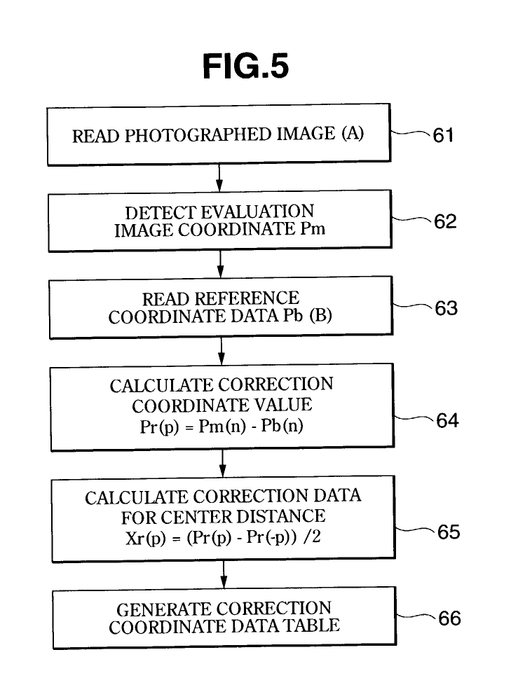

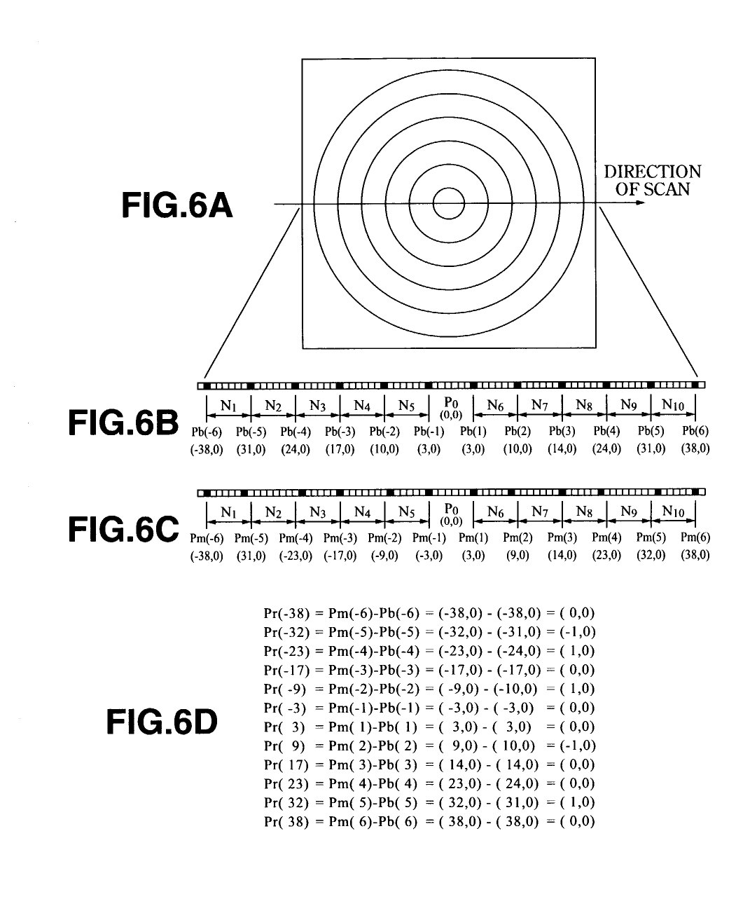

Next, a process of generating a table defining the conditions of correction to be executed by a personal computer 3 will be explained by referring to FIG. 5 and FIG. 6.

Step 61 in FIG. 5 takes in annular image data (A) produced by photographing zebra patterns 12 that are divided at equiangular intervals in angle of elevation as seen from the PAL lens and which are arranged to surround the PAL lens 1, as shown in FIG. 4. The next step 62 scans the annular image along a horizontal line passing through a center of the image, as shown in FIG. 6A, to extract pixel data on the horizontal line and determine coordinates Pm of circle patterns. Since the circle patterns have black pixels, detecting the black pixels during the scanning of the circle patterns can determine the coordinates Pm of pixels where the circle patterns exist. FIG. 6B show reference coordinates arranged at equal intervals. The coordinates detected by the scan is shown in FIG. 6C. As to the coordinate representation in FIG. 6A and FIG. 6B, the center of the image is taken as an origin (0, 0). A coordinate (2, 1), for example, indicates a point shifted two pixels to the right and one pixel up from the origin. An evaluation image shot by an ideal PAL lens with no distortions describes equidistantly spaced concentric circles, so that their intervals N1, N2, . . . , N10 agree with the reference coordinates of FIG. 6B. Actual lenses, however, have vertical distortions and their detected coordinate intervals are uneven, as shown in FIG. 6C.

Step 63 reads reference coordinate data. The reference coordinate data is fixed and therefore can be taken in simply by reading prerecorded data. Then, in step 64 a difference is taken between the measured coordinates and the corresponding reference coordinates and this difference is used as correction coordinate data for calculating correction data. The process of this calculation and its result are shown in FIG. 6D.

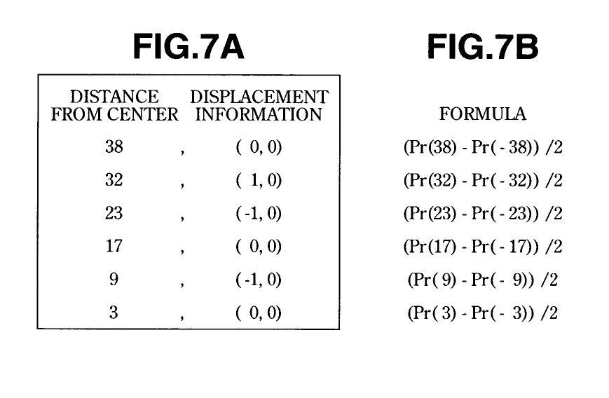

According to a calculation formula shown in step 65, the distance of each circle from the image center is calculated as shown in FIG. 7B and at the same time displacement information representing a deviation of each circle from the reference coordinate is calculated. Then, step 66 generates an image correction data table as shown in FIG. 7A and displays it on the monitor. The image correction data requires vertical correction data that relates a radial position of the annular image with a height position of the panoramic image for each pixel.

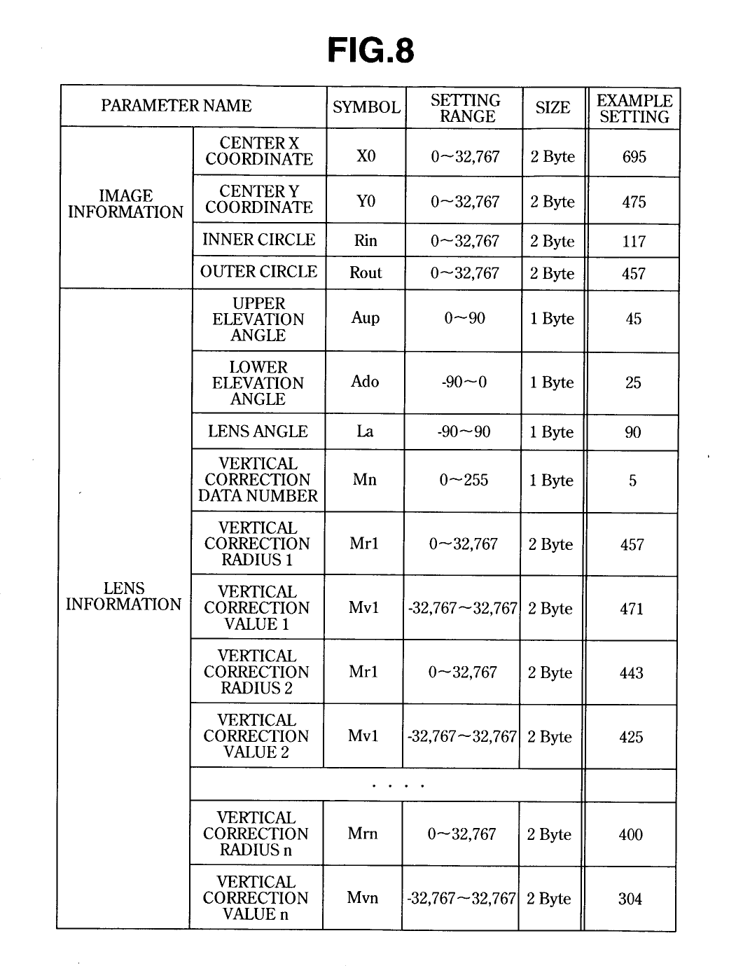

As described above, in converting an annular image into a panoramic image, a variety of image conversion parameters are necessary, including a center coordinate, an inner circle radius, an outer circle radius and vertical correction data representing a vertical distortion correction condition for each pixel of the image. FIG. 8 illustrates an example of these image conversion parameters.

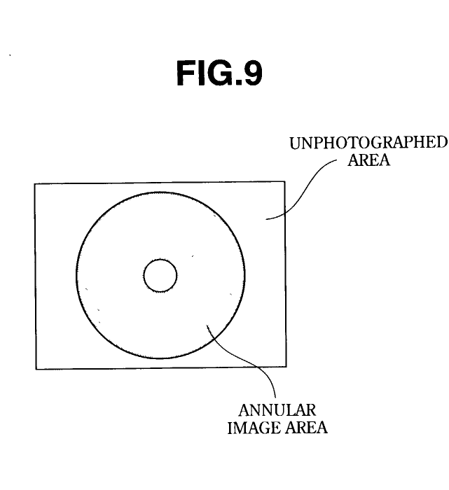

In this invention, these image conversion parameters are recorded in an unphotographed area other than the annular image area as shown in FIG. 9.

FIG. 8 shows an example of image conversion parameters, such as image conversion parameter names, setting ranges, data sizes and example settings. As for the vertical correction value, it consists of a plurality of data and thus an intermediate value is not shown in the table.

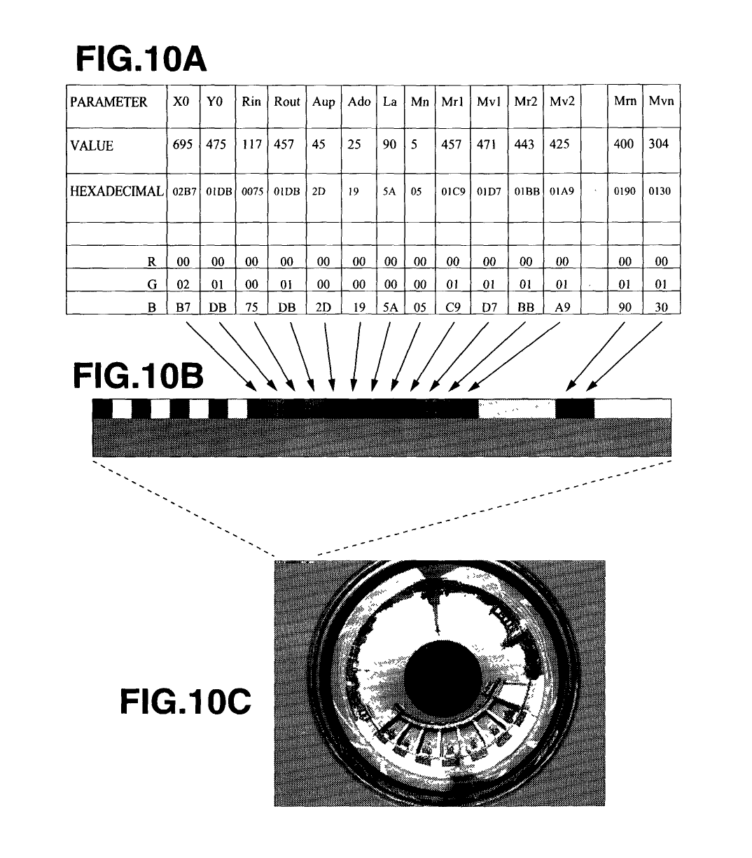

With reference to FIG. 10, a method of converting the image conversion parameters into color information and embedding it in an unphotographed area of the image data will be described.

The conversion parameters are all three bytes or less long and therefore they can be divided and allocated to RGB data for each pixel by converting them into a hexadecimal data. For example, in FIG. 10A when a value 695 for a parameter X0 is given in hexadecimal notation, it is expressed as 0002B7. Dividing this value into units of one byte (two digits each) and allocating the divided value to each color results in 00 being assigned to R (red), 02 to G (green) and B7 to B (blue). In this way, each parameter is converted into color information and recorded in an unphotographed area of the annular image. The format in which these parameters are written is shown magnified in FIG. 10B.

In FIG. 10B, eight pixels from the left end are written with a header data which indicates that conversion parameters are embedded in the subsequent pixels. The subsequent pixels are written with parameter data and the last four pixels at the right end are written with end data signifying an end of parameter data. These conversion parameters are written in an unphotographed area at an upper left end of the annular image as shown in FIG. 10C. The order of data is fixed as indicated in FIG. 10A.

A process to retrieve the conversion parameters embedded as described above involves reading pixel values successively from the upper left end toward right and extracting three bytes of data from the color information RGB values thus read out.

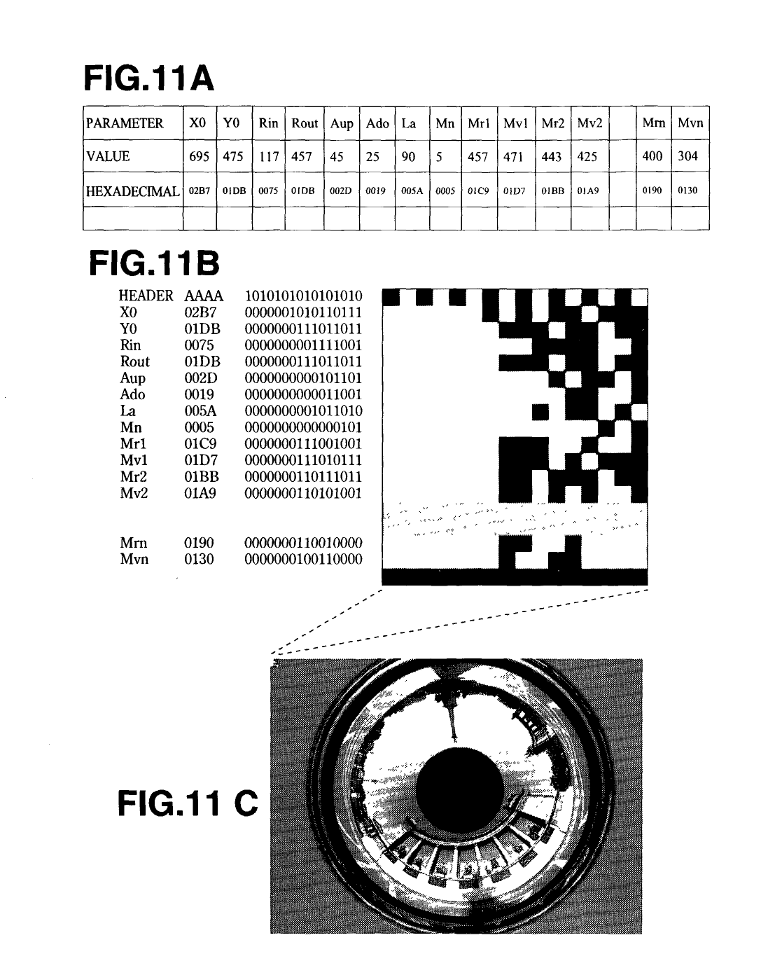

Next, by referring to FIG. 11, a method of converting the image conversion parameters into binary figures and embedding them in the annular image will be explained.

Example image parameters shown in FIG. 11A to be converted are the same as those used in FIG. 10. The image parameters are each converted into a binary number of 16 digits. The binary number is represented by two colors, black and white, as shown magnified in FIG. 11B. Here, each digit of the number may match a single pixel or a plurality of pixels. In this embodiment each digit is represented by a block of four pixels, two pixels wide and two pixels long, and colored with either black or white. The data is written in the unphotographed area from the top down in the order of the header, conversion parameters and end data. These conversion parameters are embedded in the upper left corner of the annular image as shown in FIG. 1C. To read the conversion parameters from pixels involves determining the number of pixels used for each digit from the header, reading 16 digits of image information from left to right according to that pixel number, and converting a binary number of the 16 digits retrieved from the binary figures into a decimal number. This is repeated until the bottom row of binary figures is processed.

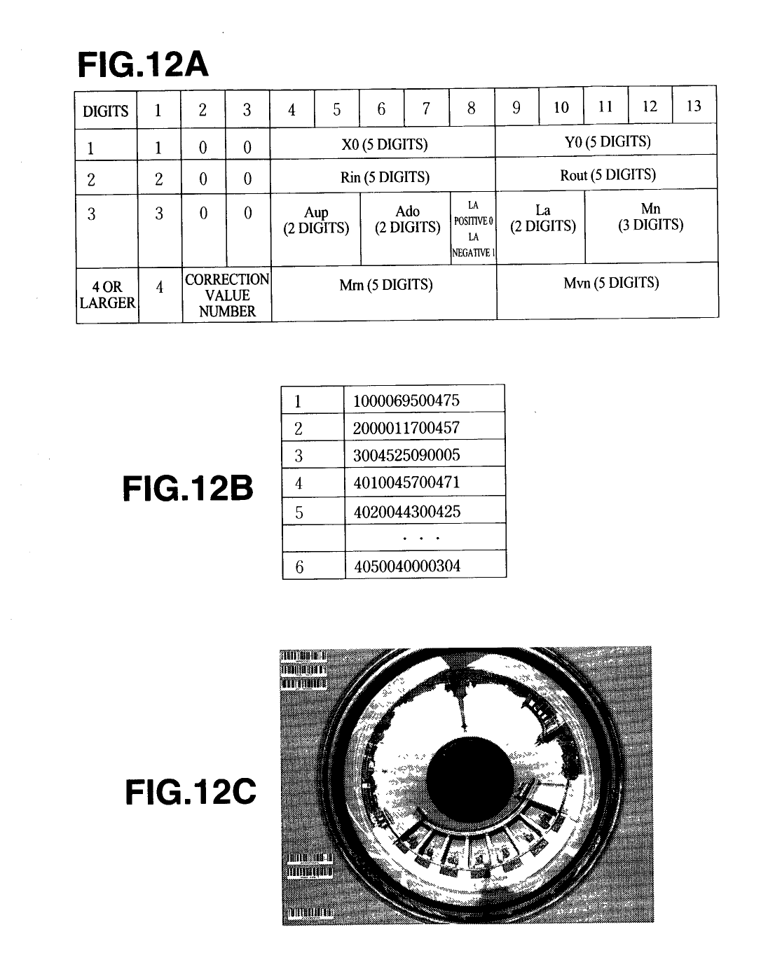

Next, by referring to FIG. 12, a method of writing the image conversion parameters in bar codes will be explained.

FIG. 12A is a bar code setting table. Symbols in the table use those of the parameter table of FIG. 8. A number represented by one bar code is 13 digits long, as shown in FIG. 12B, and thus four or more bar codes are used to represent all the parameters. The first digit at the left end of the car code is used to identify the parameter represented by the bar code. These bar codes are embedded in the unphotographed area as shown in FIG. 12C.

To read the conversion parameters from the bar codes, numbers indicated under the bar code are read and a desired number is entered as from a keyboard to specify whether the bar code reader will be used or not. Even when an image is a printed image on paper or the like, this embodiment makes it possible to convert the printed image into a panoramic image by reading the printed image by a scanner for transformation into electronic data and reading the conversion parameters from the bar codes.

Although in the embodiments above the image conversion parameters have been described to be embedded in the upper left corner of the annular image, they may be embedded in any desired location in an unphotographed area as long as the writing side and the reading side share information on a parameter writing location. In addition to the image conversion parameters, other information such as messages and photograph recording information can be embedded in the similar manner.

Since the image conversion parameters are added to the annular image data in such a way as to keep the image conversion parameters within the image data from disturbing the image data format, the annular image can be displayed by a generally available image display application software. Further, because the conversion parameters are written in an unphotographed area, they are prevented from affecting the panoramic image and thus its image quality is not degraded.

Further, since the image conversion parameters are written in an unphotographed area of the annular image in the form of bar codes or numbers, even when an annular image is printed on paper or the like, the image conversion parameters can be read from a printed matter. Therefore, by converting the printed image into image data as by scanner, it is possible to convert an annular image on a printed medium into a panoramic image without having to retrieve the image conversion parameters from separate locations.

What is claimed is:

1. A method of recording image conversion parameters in an annular image, comprising a step of:
recording the image conversion parameters in an image format in an unphotographed area of the annular image shot by an omnidirectional camera, the image conversion parameters being used to convert the annular image into a panoramic image.

2. A method according to claim 1, wherein the image format in which the image conversion parameters are recorded is color codes.

3. A method according to claim 1, wherein the image format in which the image conversion parameters are recorded is binary codes.

4. A method according to claim 1, wherein the image format in which the image conversion parameters are recorded is bar codes.

5. Annular image data having image conversion parameters recorded in an image format in an unphotographed area of an annular image shot by an omnidirectional camera, the image conversion parameters being used to convert the annular image into a panoramic image.

6. Annular image data according to claim 5, wherein the image format in which the image conversion parameters are recorded is color codes.

7. Annular image data according to claim 5, wherein the image format in which the image conversion parameters are recorded is binary codes.

8. Annular image data according to claim 5, wherein the image format in which the image conversion parameters are recorded is bar codes.
